(19) United States
(12) Patent Application Publication
(10) Pub. No.: US 2026/0104985 A1
(43) Pub. Date: Apr. 16, 2026

(54) SYSTEM TO VERIFY OPEN WORLD DATA APPLIED TO VEHICLE APPLICATIONS

(71) Applicant: Honeywell International Inc., Charlotte, NC (US)

(72) Inventors: Sreenivasan Govindillam K, Bangalore (IN); Kalimulla Khan, Bangalore (IN)

(73) Assignee: Honeywell International Inc., Charlotte, NC (US)

(21) Appl. No.: 19/076,321

(22) Filed: Mar. 11, 2025

(30) Foreign Application Priority Data
Oct. 15, 2024 (IN) 202411078131

(51) Int. Cl. G06F 11/3668; G01C 21/00

(52) U.S. Cl. CPC G06F 11/3668; G01C 21/3837

(57) ABSTRACT

A system to verify open world data applied to vehicle applications of vehicle systems is provided. A quality advisor provides an interface between the open world data and a plurality of vehicle applications. The quality advisor includes a memory and a processor. The memory is used to store operating instructions and at least one database that includes functional links between vehicle applications of the plurality of vehicle applications. The processor is configured to verify the open world data by determining if the open world data provides expected insights across the vehicle applications with the functional links stored in the at least one database.

### CROSS-REFERENCE TO RELATED APPLICATION

This application claims priority to Indian Provisional Patent Application No. 202411078131 filed on Oct. 15, 2024, the contents of which are incorporated herein by reference in their entirety.

### BACKGROUND

It is common for an aircraft mission to be accomplished by integrating internal avionic data provided by aircraft applications from aircraft systems with open world data provided from open world applications. Open world data is external data generated outside of the avionic systems from external applications from external devices. The use of open world data lessens resources needed by the internal applications of the avionic or aircraft systems in accomplishing the aircraft mission. Further, the integration allows for the revising of aircraft operation parameters at any time during the aircraft mission which provides for safer and optimized operations. Integrated data, may be related to, aircraft state data, current state of flight plan data, RADAR/SATCOM data and weather data, etc. Examples of aircraft applications that may integrate open world data include flight planning applications, localization applications, take off runways analysis applications, display applications, radio management applications, etc. Examples of where open world data may be used in avionic applications include flight plan optimization with defined criteria functions, situational awareness functions and handling emergencies functions.

The transfer of the open world data to the aircraft applications of the aircraft systems needs to be assured as secure, since compromised open world data may result in errors in functions of the vehicle applications. Further, since modern avionics may integrate many aircraft functions together, one error in open world data may affect several aircraft functions of several aircraft applications (i.e. there are functional links between functions provided by different applications of the aircraft systems).

For the reasons stated above and for other reasons stated below which will become apparent to those skilled in the art upon reading and understanding the present specification, there is a need in the art for an effective and efficient system to verify that open world data is domain safe and can be used by vehicle applications of vehicle systems.

### SUMMARY

The following summary is made by way of example and not by way of limitation. It is merely provided to aid the reader in understanding some of the aspects of the subject matter described. Embodiments provide a quality advisor that monitors open world data.

In one embodiment, a system to verify open world data applied to vehicle applications of vehicle systems is provided. The system includes a plurality of vehicle applications and a quality advisor. The plurality of the vehicle applications configured to at least in part provide information to control operations of a vehicle. The quality advisor provides an interface between the open world data and the plurality of vehicle applications. The quality advisor includes a memory and a processor. The memory is used to store operating instructions and at least one database that includes functional links between vehicle applications of the plurality of vehicle applications. The processor is configured to implement the operating instructions stored in the memory. The processor is configured to verify the open world data by determining if the open world data provides expected insights across the vehicle applications with the functional links stored in the at least one database. The processor is further configured to do at least one of preventing the vehicle applications from receiving the open world data and presenting the open world data to a vehicle operator when the processor determines that the open world data does not provide the expected insights across the vehicle applications with the functional links.

In another embodiment, another system to verify open world data applied to vehicle applications of vehicle systems is provided. The system includes a plurality of vehicle applications and a quality advisor. The plurality of vehicle applications are configured to at least in part control operations of a vehicle. The quality advisor provides an interface between the open world data and the plurality of vehicle applications. The quality advisor includes a memory and processor. The memory is used to store operating instructions and at least one database that includes functional links between the plurality of vehicle applications. The processor is configured to implement the operating instructions stored in the memory. The processor is configured to run tests in a background with data generated by vehicle systems as the vehicle traverses through a travel path to determine expected insights associated with the plurality of vehicle applications. The processor is configured to verify the open world data by comparing open world data results with expected insights across vehicle applications with the functional links. The processor is further configured to provide the open world data to the vehicle applications when the processor determines the open world results are within the acceptable ranges of the expected insights across the vehicle applications with the functional links.

In still another embodiment, a method to verify open world data applied to vehicle applications of vehicle systems is provided. The method including interfacing communications between an open world data source and the vehicle systems with a quality advisor; generating expected insights for functions executed by the vehicle applications using data provided by the vehicle systems as a vehicle that contains the vehicle system at least transverses along a travel path; comparing open world data results from the open world data provided by the open world source with the expected insights across vehicle applications with functional links using the quality advisor; and providing the open world data to at least one vehicle application when the comparing of the open world data results with the expected insights across the vehicle applications with functional links are within an acceptable range.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a vehicle that includes a system to verify open world data for use in vehicle applications of vehicle systems according to an example aspect of the present invention;

FIG. 2 illustrates an expected insight generation flow diagram according to an example aspect of the present invention;

FIG. 3A illustrates a verifying open world data flow diagram according to an example aspect of the present invention;

FIG. 3B illustrates an alarm response flow diagram according to an example aspect of the present invention;

FIG. 3C illustrates an insight integrity flow diagram according to an example aspect of the present invention;

FIG. 4 is a block diagram of an aircraft that includes a system to verify open world data for use in vehicle applications of vehicle systems according to an example aspect of the present invention;

FIG. 5A is an illustration of link functions relating to fuel availability according to an example aspect of the present invention;

FIG. 5B is an illustration of a fuel consumption related insight gathering flow diagram according to an example aspect of the present invention;

FIG. 5C is an illustration of a verifying fuel consumption open world data flow diagram according to an example aspect of the present invention;

FIG. 6A is an illustration of link functions relating to a flight offset according to an example aspect of the present invention;

FIG. 6B is an illustration of a flight path offset function related expected insight gathering flow diagram according to an example aspect of the present invention;

FIG. 6C is an illustration of a verifying flight off set path open world data flow diagram according to an example aspect of the present invention;

FIG. 7A is an illustration of link functions relating to altitude and temperature according to an example aspect of the present invention;

FIG. 7B is an illustration of an altitude/temperature linked function flow diagram according to an example aspect of the present invention;

FIG. 7C is an illustration of an altitude/temperature open world data flow diagram according to an example aspect of the present invention;

FIG. 8A is an illustration of link functions relating to a landing example according to an example aspect of the present invention;

FIG. 8B is an illustration of an expected landing insight gathering flow diagram according to an example aspect of the present invention;

FIG. 8C is an illustration of a verifying landing open world data flow diagram according to an example aspect of the present invention; and

FIG. 8D is an illustration of another verifying landing open world data flow diagram according to an example aspect of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

The term “open world data” as used herein shall mean data that is generated outside of certified systems of a vehicle. In the context of avionic examples, open world data may come from non-certified systems such as an electronic flight bag (EFB), an installed non-certified open world computer in the flight deck, a communication interface to a cloud application, etc.

Embodiments of the present invention provide a system for verifying that open world data is domain safe and can be used by vehicle applications of vehicle systems. Example embodiments include a quality advisor that monitors open world data. The quality advisor is self-contained and provides an interface between the open world data and vehicle systems. The avionic hosted (vehicle hosted) quality advisor includes at least a processor and memory. The memory stores operating instructions implemented by the processor and at least one database that includes at least function link vehicle applications of the vehicle systems. The quality advisor is designed to have two-way communications with all vehicle systems that are configured for integrated assessment. The quality advisor verifies open world data by determining if the open world data provides expected results across linked functions of vehicle applications.

In one example, the quality advisor functions as a continuous built in test (CBIT) that covers all functional and integrated scenarios used by the vehicle applications. The CBIT may be realized as a separate partition or process within an avionics system in an example. The quality advisor runs tests in the background with data generated by the vehicle applications of the vehicle systems to determine expected insights of the linked functions across vehicle applications. The expected insights are compared to open word data results using the open world data. The quality advisor may generate an alarm response when suspicious open world data is detected.

Suspicious world data results are results of functions of applications that are inconsistent with expected insights that should occur due to the linked functions in the database. That is, for example, if open world data results in a first world data result generated from a first function of a first application, a second world data result generated from a second related function of a second application should match or be within an acceptable range of an expected insight result for the second related function. Suspicious open world data may be rejected or presented to a pilot (vehicle operator) for review. Open world data is verified with expected insights per linked function, may be accepted with or without vehicle operator consent in an example.

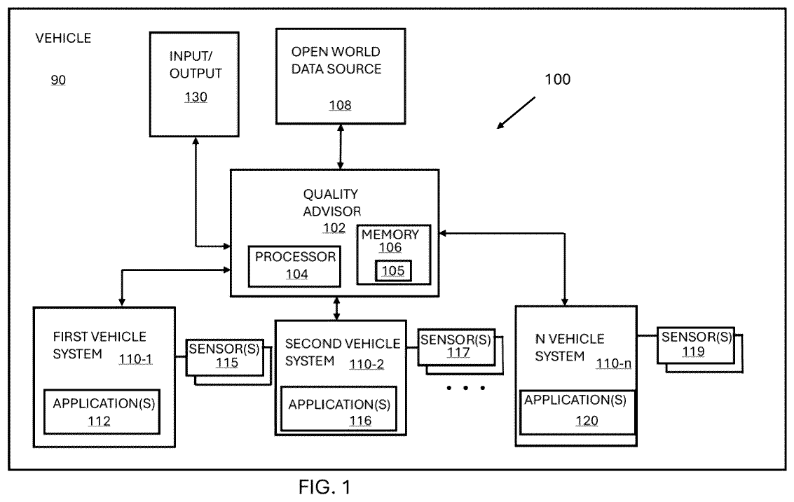

FIG. 1 illustrates a block diagram of a vehicle 90 that includes a system 100 to verify open world data used by vehicle applications of vehicle systems. The system 100 in this example, includes a quality advisor 102. The quality advisor 102 includes a processor 104 and a memory 106.

In general, processor 104 may include any one or more of a microprocessor, a digital signal processor (DSP), an application specific integrated circuit (ASIC), a field program gate array (FPGA), or equivalent discrete or integrated logic circuitry. In some example embodiments, processor 104 may include multiple components, such as any combination of one or more microprocessors, one or more controllers, one or more DSPs, one or more ASICs, one or more FPGAs, as well as other discrete or integrated logic circuitry. The functions attributed to processor 104 herein may be embodied as software, firmware, hardware or any combination thereof. Processor 104 may be part of a system controller or a component controller including an aircraft system controller. Memory 106 may include computer-readable operating instructions that, when executed by processor 104 provide advisor functions of system 100. Such advisor functions may include the functions of verifying open world data that is to be used by vehicle applications of vehicle systems as described below. The computer readable instructions may be encoded within memory 106. Memory 106 is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium. Memory 106 further includes a database 105 that includes functional links between vehicle applications and expected insights associated with functions.

The quality advisor 102 provides an interface between an open world data source 108 and vehicle systems 110-1 through 110-n. The quality advisor 102 may be a standalone system that is vehicle certified or it may be part of a certified system, such as an aircraft certified system. The quality advisor 102 is in communication with the open world data source 108. The open world data source 108 provides open world data that may be used by applications of one or more of the vehicle systems 110-1 through 110-n. For example, the first vehicle system 110-1 is illustrated as including system application(s) 112, the second vehicle system 110-2 is illustrated as including system application(s) 116 and the N vehicle system 110-n is illustrated as including system application(s) 120. The vehicle applications 112, 116 and 120 execute functions that generate information that may at least in part be used to control operations of the vehicle 90. Each of the systems 110-1 through 110-n may be in communication with one or more sensors 115. The example of FIG. 1 illustrates the second vehicle system in communication with sensors 115. The applications 112, 116, 120 of the vehicle systems 110-1 through 110-n may further use sensor data from sensors 115, 117 and 119 in executing system functions.

Often applications of vehicle systems perform functions that are linked because the results of one function will have an impact on the result of another function. For example, in an aircraft application, the result of an aircraft weight function will have a relationship with a result of an available fuel function, since the weight of the fuel in the aircraft provides part of the weight of the aircraft. The linked functions associated with vehicle 90 are stored in database 105 of memory 106. Processor 104, implementing operating instructions stored in memory 106, verifies open world data using the functional links between vehicle applications stored in database 105 as described below.

Processor 104, in an example, runs tests in the background, based on the stored instructions, the linked system functions, and data obtained from the vehicle systems 110-1 through 110-n to determine expected insights across the linked system functions of the applications 112, 116 and 120. Background processing refers to processing that runs independently without the need for user input. In an example, the running of the tests in the background continues throughout a period of preparing a vehicle for travel and as the vehicle traverses across a travel path. Processor 104 stores the expected insights and the linked function information in database 105 in memory 106.

If open world data is to be used by a system application 112, 116 or 120, processor 104 of the quality advisor 102 determines open world data results based on the open world data across the linked functions of applications 112, 116 and 120. Processor 104 then compares the determined world data results with the stored expected insights across applications 112, 116 and 120 having linked functions. Processor 104, in an example, then determines if a difference, if any, is within a range of the expected insights across the different applications 112, 116 or 120. If one or more of the world data results are not within a defined range of an associated expected insight result, processor 104 generates an alarm response in an example.

Vehicle 90 in this example, further includes an input/output 130 that is in communication with processor 104. The input/output may include a display, an audio device and input device. In one example, processor 104 provides the alarm response to the display of the input/output providing a user an option to disregard the open world data, allow the open world data to be sent to the vehicle applications, or request new open world data as discussed below.

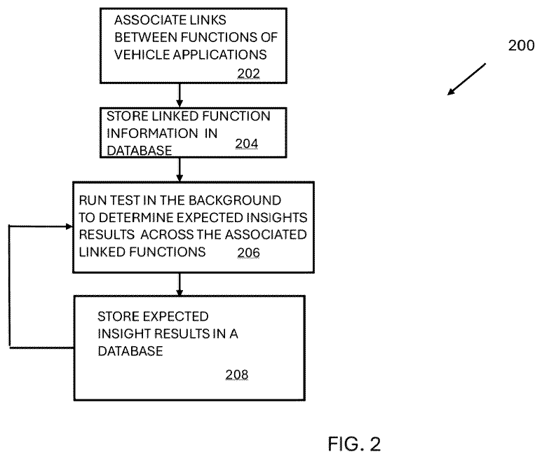

FIG. 2 illustrates a method of generating expected insights in an expected insight generation flow diagram 200. The expected insight generation flow diagram 200 is provided as a sequential sequence of blocks in FIG. 2. The sequence of blocks may occur in a different order or even in parallel in other embodiments. Hence, the present invention is not limited to the sequential sequence of blocks in FIG. 2.

At block 202, links between functions of vehicle applications are associated with each other (functional links). This may be done with processor 104 of the quality advisor 102 implementing instructions stored in memory 106. The functional links, or linked functions, may be determined by applying first data to a first function and identify results of other functions that are impacted by the first data. Linked function information is stored in database 105 at block 204. In other examples, the functional links may be determined by another system and stored in database 105.

Tests are run in the background to determine expected insights across the linked functions of the vehicle applications at block 206. The test may function as a continuous built in self-test covering all functional and integrated scenarios. Data used in the tests are provided by the vehicle systems 110-1 through 110-n as the vehicle prepares for and traverses through a travel path to the completion of a mission. The data may include fuel consumption rates, vehicle speeds, wind speed, traffic information, weather information, vehicle weight information, fuel available information, temperature information, altitude information, etc.

Expected insights are stored in database 105 at block 208. Each expected insight result is associated with the function that generated the insight result so processor 104 can associate expected insights with the function that created it. Expected insight result flow diagram 200 then continues at block 206 running the test. In one example the process continues until the vehicle has completed its mission.

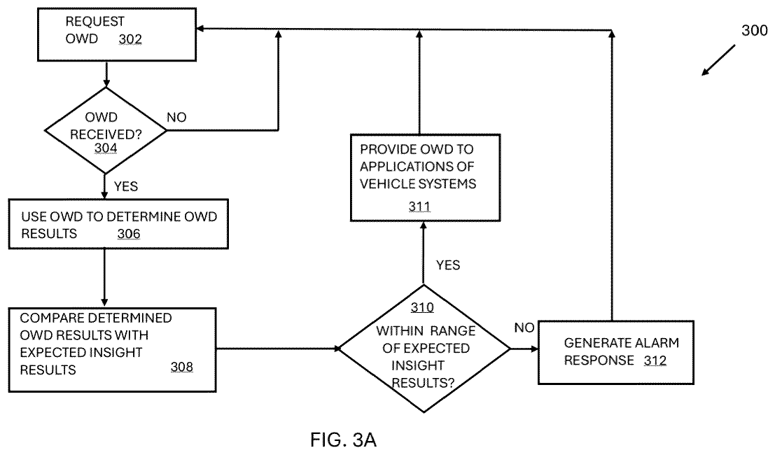

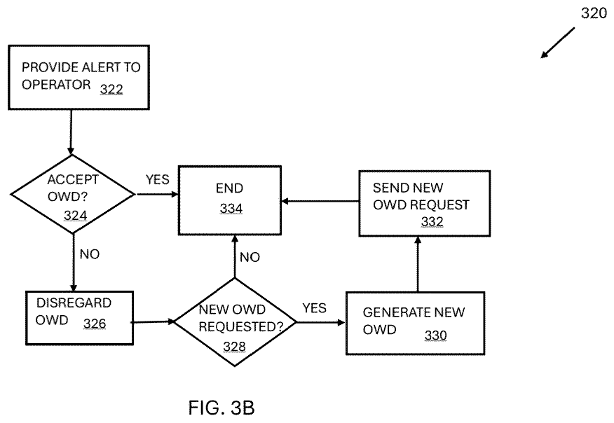

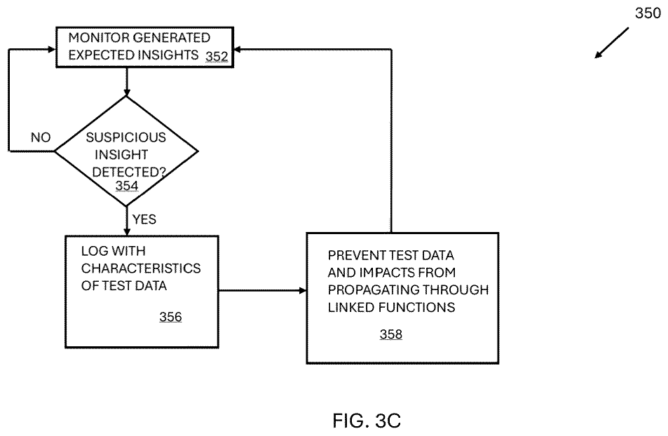

A method of verifying open world data applied to vehicle applications of vehicle systems is illustrated in the verifying open world data flow diagram 300 of FIG. 3A. The verifying open world data flow diagram 300 is provided as a sequential sequence of blocks in FIG. 3A. The sequence of blocks may occur in a different order or even in parallel in other embodiments. Hence, the present invention is not limited to the sequential sequence of blocks in FIG. 3A.

At block 302 of the verifying open world data flow diagram 300, a request for open world data (OWD) occurs. This may originate from a vehicle system needing further information or resources to generate data used in a function executed by an application of the system. It is determined at block 304 if open world data has been received. If it is determined at block 304 that open world data has not been received, the process continues at black 302 monitoring for open world data. If it is determined at block 304 that open world data has been received, the quality advisor 102 determines open world data results at block 306. In an example, the quality advisor 102 implements applications stored in memory 106 with the processor 104 to determine the open world data results. The determined open world data results are then compared with the expected insights in block 308 also determined by the quality advisor as discussed above. For example, if open world data relates to a vehicle efficiency and the open world data results is a fuel efficiency determination, the quality advisor will look at expected insights across vehicle applications with linked functions, such as in this example, applications that relate to vehicle weight and applications that relate to environmental conditions determined by different vehicle applications.

At block 310 it is determined if the open world data results across the vehicle applications with linked functions are within a range of expected insights for the applications. The range may be set based on one of expected variance errors and set safety variance limits for devices providing data used by the applications. If it is determined at block 310 the determined open world data results across the application with linked functions are all within accepted ranges of expected insights, the open world data is provided to the applications of the vehicle systems at block 311. The process then continues monitoring for open world data at block 302.

If it is determined at block 310, however, that the determined open world data results across the application with linked functions is not within accepted ranges with at least one expected insight result, an alarm response is generated at block 312. The process then continues monitoring for open world data at block 302. The alarm response may include a message provided by a display of the input/output 130 or a speaker of the input/output. In one example, a vehicle operator is given the option of accepting the open world data to be used with the vehicle applications even after the alarm response has been generated through an input of the input/output 130. In one example, the alarm response prevents the open world data from being used by the vehicle applications.

An example of a method of implementing an alarm response is illustrated in an alarm response flow diagram 320 of FIG. 3B. The alarm response flow diagram 300 is provided as a sequential sequence of blocks in FIG. 3B. The sequence of blocks may occur in a different order or even in parallel in other embodiments. Hence, the present invention is not limited to the sequential sequence of blocks in FIG. 3B.

At block 322 an alert is provided to an operator of vehicle 90. The alert may be provided by a display of the input/output 130. In another example, the input/output provides an audio alert. Further in an example, the visual alert provided by the display is accompanied by an audio alert. The alert in this example describes the open world data that caused the alarm response to be issued. The alert may also identify why the open world data caused the alarm response to be generated. The operator, in this example, is given an option to accept the open world data even though it generated the alarm response at block 324. If the operator decides to accept the open world data at block 324, the process ends at block 334. An input device, such as, but not limited to, a button or switch that is part of the input/output 130 may be used by the vehicle operator to respond to the option to accept the open world data.

If the operator decided to not accept the open world data at block 324, the open world data is disregarded at block 326 in this example. The open world data may be disregarded by not forwarding the open world data on for use by the vehicle systems. The vehicle operator in this example is then provided with an option to request for new open world data if desired at block 328. If the vehicle operator does not request new open world data be generated at block 328, the process ends at block 334. If the vehicle operator does request new open world data be generated at block 328, a new open world data request is generated at block 330. In an example, the request may be the same or similar to the original request from a vehicle system. At block 332, the new request is sent to the open world data source 108. The process then ends at block 334.

As discussed above, the quality advisor 102 is running a continuously built in self-test as the vehicle traverses through its travel path in the completion of its mission. With use of the linked functions and the generated expected insights, suspicious insights may be logged with the characteristics of the test data. The suspicious test data and impacts of the test data are not propagated further to maintain the integrity of the expected insights.

A method of maintaining the integrity of the generated insights is provided in an insight integrity flow diagram 350 of FIG. 3C. The insight integrity flow diagram 350 is provided as a sequential sequence of blocks in FIG. 3C. The sequence of blocks may occur in a different order or even in parallel in other embodiments. Hence, the present invention is not limited to the sequential sequence of blocks in FIG. 3C.

At block 352 of the insight integrity flow diagram 350, generated insights from the test data are monitored. As discussed above, the test data is provided by the vehicle systems as the vehicle travels along a travel path to complete a mission. At block 354 it is determined if suspicious insights have been detected. One method of determining if suspicious insights are detected is where test data results in insights across applications with linked function that are inconsistent with past insights (i.e., outside a range that would be expected).

If it is determined at block 354, that no suspicious insight has been detected, the process continues at block 352 monitoring generated insights. If it is determined at block 354, that a suspicious insight has been detected, the insight is logged along with characteristics of the test data that produced the insight at block 356. This allows for another system to review if there are any issues with the vehicle system that produced the test data. At block 358, the test data that generated the suspicious insight is removed to prevent impacts on the functions and the propagation of impacts of the test data through the linked functions. The process then continues at block 352 monitoring generated insights.

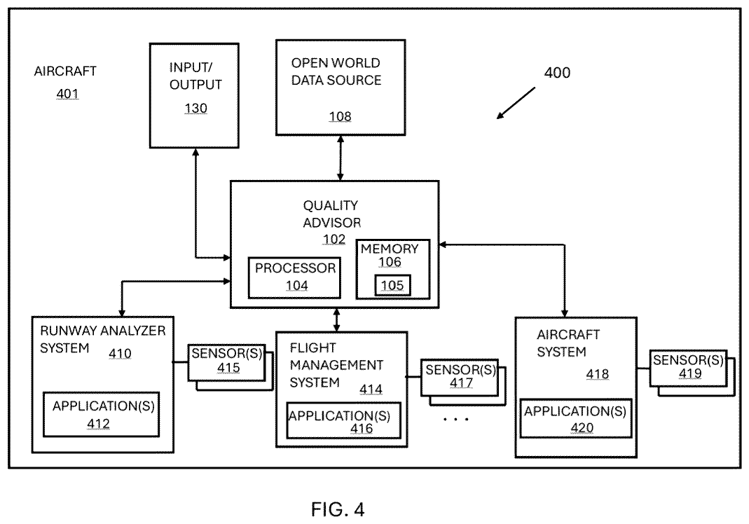

An example of an avionic application of a system 400 in an aircraft 401 used to verify open world data for aircraft systems is illustrated in FIG. 4. System 400 in this example, includes quality advisor 102. Quality advisor 102 includes processor 104 and a memory 106 as discussed above. System 400 also includes the open world data source 108 and the input/output 130 discussed above. Examples of an open world data source 108 include an electronic flight bag (EFB), an installed non-certified open world computer in the flight deck, and a communication interface to a cloud application. The open world data source 108 provides a distributed computing mechanism in a cockpit that is not limited by memory and CPU constraints of a vehicle system (avionic system). Further, external applications in the open world data source 108 can provide fast and intensive computations to evaluate multiple scenarios and augmentation of data from multiple sources. Insights derived by open world data include for example, but not limited to, mission efficiency information (fuel, time or operational efficiencies) and safety information.

Examples of avionic applications used by aircraft systems that may integrate open world data include flight planning applications, localization applications, take off runways analysis applications, landing runways analysis applications, displays applications, radio management applications, etc. Examples of where open world data may be used in aircraft applications to supplement internally generated data include aircraft state data, current state of flight plan data, RADAR/SATCOM data, weather data, etc. Aircraft state data may include position aircraft data, available fuel data, a current speed of the aircraft, etc. provided by a flight management system 414 using navigation sensors, such a global positioning satellite system or inertial navigation system of the aircraft. The current state of the flight plan data may also be generated by the flight management system 414. Other examples of where open world data may be used in avionic applications include flight plan optimization with defined criteria, situational awareness and handling emergencies.

System 400 of FIG. 4, used to verify open world data used by aircraft applications of aircrafts system in this example, includes a runway analyzer system 410 with applications 412, a flight management system 414 with applications 416 and another aircraft system 418 with applications 420. An example of another aircraft system is a wind validator system, a traffic alert and collision avoidance system, a communication system, a radar system, etc. Each aircraft system may be in communication with associated sensors 415, 417 and 419 used to gather sensor data. The sensor data may be used by the respective vehicle applications 412, 416 and 420 in executing the associated functions. Examples of sensors 417 providing sensor data to the flight management system 414 include, but are not limited to, a fuel sensor, a global positioning sensor, an inertial navigation system, a temperature sensor, an altitude sensor, etc.

Examples of vehicle applications, used in aircraft systems and across different aircraft systems, with linked functions include for example, an aircraft weight function determined by application 416 in the flight management system 414 that is linked to a fuel consumption determination function in a different application 416 of the flight management system 414 that is also linked to a runway analysis function determined in an application 412 in the runway analyzer system 410 of the runway analyzer. Other examples of linked functions include a lateral flight path offset function (which may be due to avoid weather) determined by an application 416 in the flight management system 414 that is linked to a traffic or proximity advisories function executed by an application in a traffic alert and collision avoidance system and wind temperature setting functions that are linked with weather functions determined with an application in a wind validator system.

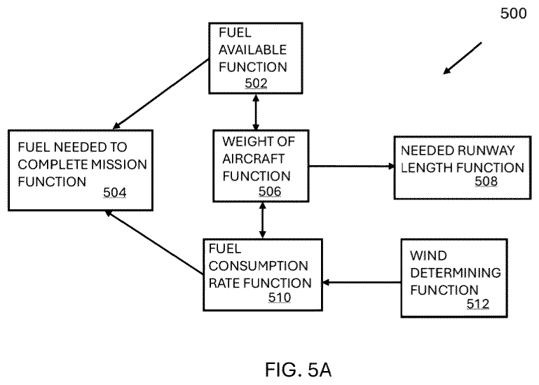

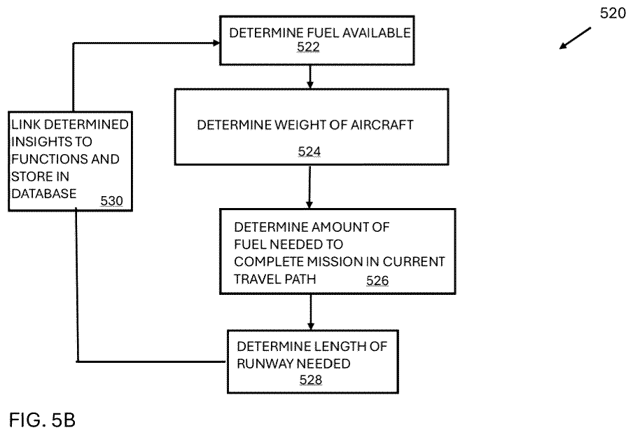

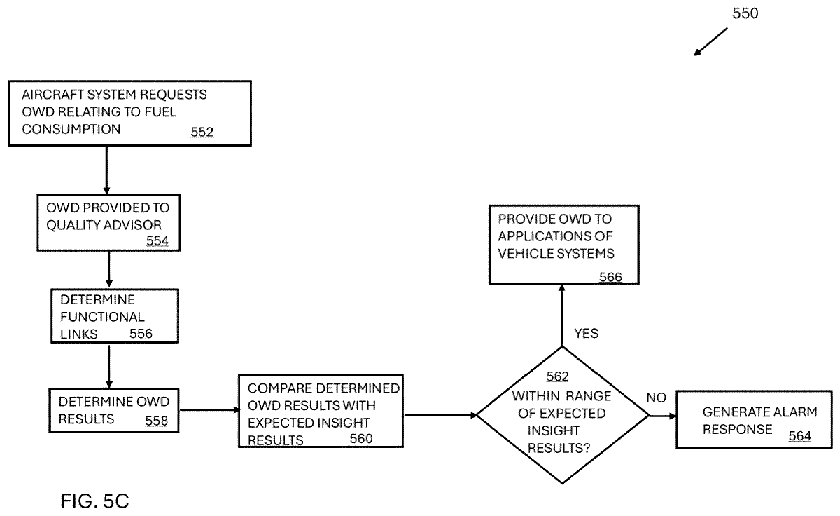

An example of linked functions is illustrated in the block diagram of linked functions 500 of FIG. 5A. In the example of FIG. 5A, a fuel available function 502 determines how much fuel is available in the aircraft as the aircraft travels along a travel path. The fuel available function 502 is linked to a fuel needed to complete the mission function 504. The fuel available function is used to ensure the aircraft has enough fuel to complete the mission. Both the fuel available function 502 and the fuel needed to complete mission function 504 may be linked to a weight of aircraft function 506. The fuel available on the aircraft will affect the weight of the aircraft so the fuel available function is linked to the weight of the aircraft. The fuel needed to complete mission function 504 is also linked to a fuel consumption rate function 510 since the rate in which fuel is being consumed with have an effect on determining how much fuel is needed to complete the mission. The fuel consumption rate function 510 in turn may be linked to the weight of aircraft function 506 and a wind determining function since the weight of the aircraft and a wind speed and direction the aircraft is encountering the wind with have an effect on the fuel consumed. In addition, the weight of the aircraft function 506 may be linked to a needed runway length function 508. The weight of the aircraft affects the stopping distance needed for the aircraft and hence the needed length of a runway to land (i.e. the heavier the aircraft the longer the runway needs to be). The linked functions are stored in database 105 of memory 106.

FIG. 5B illustrates an example method of gathering expected insights for some linked functions relating to fuel consumption. A fuel consumption related insight gathering flow diagram 520 is provided for some of the linked functions illustrated in FIG. 5A. The fuel consumption related insight gathering flow diagram 520 is provided as a sequential sequence of blocks. The sequence of blocks may occur in a different order or even in parallel in other embodiments. Hence, the present invention is not limited to the sequential sequence of blocks as set out in FIG. 5B.

At block 522, the fuel available as determined by the fuel available function 502 executed by an application of an aircraft system is determined. This may be done by reading fuel sensor data from a fuel sensor that is in communication with the application that is executing the fuel available function. At block 524, the weight of the aircraft is determined by the weight of aircraft function 506 executed by an application of an aircraft system at block 524. In one example this is done by knowing the aircraft weight without fuel and loaded with passengers and luggage and a weight per unit of fuel. As discussed above, the amount of fuel within the aircraft will be related to the weight of the aircraft which provides the functional link.

At block 526 the amount of fuel needed to complete a mission in a current travel path is determined. This may be done with one or more applications 416 in the flight management system 414. Besides the weight of the aircraft, the flight management system may also use information relating to, current aircraft speed, environmental conditions, etc., in determining fuel consumption which may be used to determine if a current amount of fuel is enough to complete the mission. At block 528 the length of a runway needed to land is determined by the needed runway length function 508 executed by an application of an aircraft system, such as application 412 of the runway analyzer 410. The weight of the aircraft at the time of the landing will impact the length of the runway needed. A determination of the weight of the aircraft at a runway at the end of the mission based on a determined weight of the aircraft and a determined fuel consumption may be determined by functions executed in applications 412 in the runaway analyzer system 410 and/or functions executed in applications 416 in the flight management system 414. At block 530 the expected insights and the function they are associated with and are stored in database 105. The process continues at block 522 as the aircraft travels along its travel path.

An example method of verifying open world data to be used in aircraft applications of aircraft systems is illustrated in a verifying fuel consumption open world data flow diagram 550 of FIG. 5C. The verifying fuel consumption open world data flow diagram 550 is provided as a sequential sequence of blocks in FIG. 5C. The sequence of blocks may occur in a different order or even in parallel in other embodiments. Hence, the present invention is not limited to the sequential sequence of blocks in FIG. 5C.

At block 552, an aircraft system requests open world data relating to fuel consumption rate in this example. The open world data source 108 may use external information regarding parameters and performance of the aircraft, weather condition information as well as other data to provide the open world data relating to fuel consumption.

At block 554, the open world data relating to fuel consumption is provided to the quality advisor 102. The quality advisor 102 then looks for functional links in the database that have a relation to fuel consumption at block 556. As illustrated in FIG. 5A there is a link between the fuel consumption rate function 510, the weight of the aircraft function 506 and the wind determining function 512 in this example. At block 558, the quality advisory 102 determines open world data results. The quality advisor 102 takes into account the effect the open world data has across the linked functions.

At block 560, the quality advisory 102 compares determined open world data results with expected insights across applications with linked functions. In this example, quality advisor may compare open world data results relating to aircraft weight and/or wind speed and direction with an aircraft weight expected insight generated by the weight of the aircraft function 506 and/or wind speed and direction expected insights generated by the wind determining function.

At block 562, it is determined if the open world data result is within an acceptable range of an expected insight result. If it is determined at block 562 that the open world data result is within the range of the expected insight result, the open world data is provided to applications of vehicle systems at block 566. If it is determined at block 562 that the open world data result is not within the range of the expected insight result, an alarm response is generated at block 564. In one example, the alarm response provides the pilot an option to disregard the open world data or accept the open world data to be used by the aircraft systems.

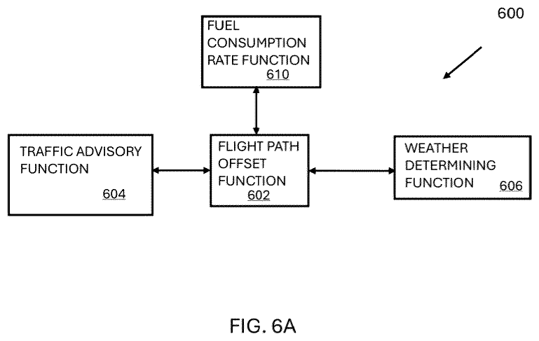

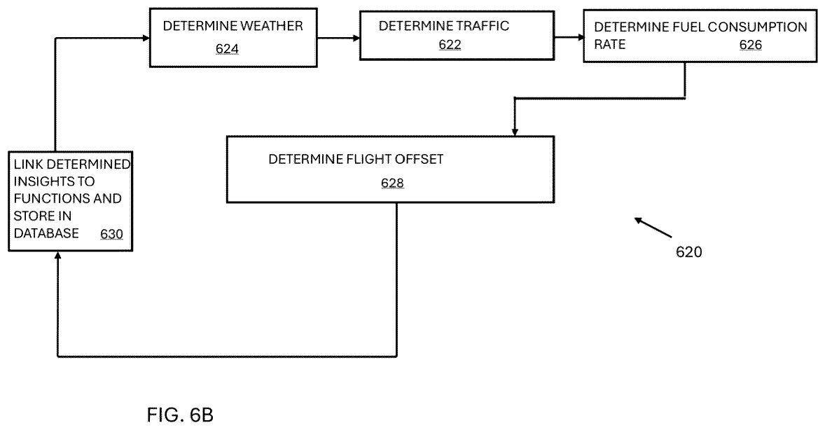

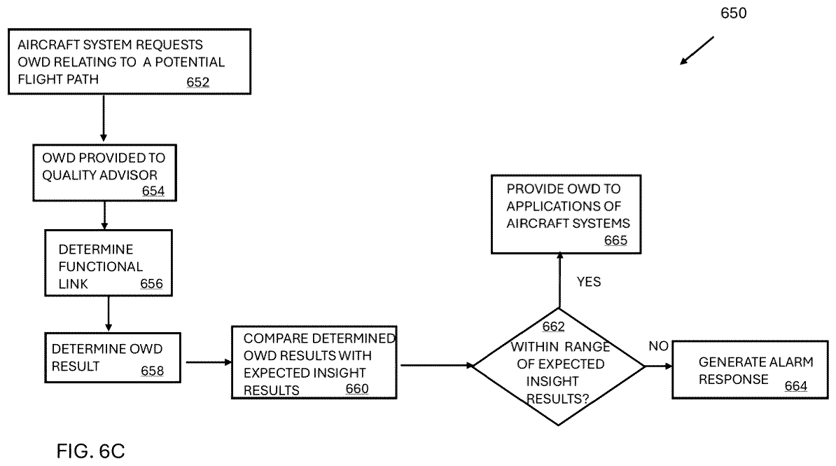

Another example of some other linked functions 600 that may be stored in database 105 of memory 106 are illustrated in FIG. 6A. The linked functions 600 in this example include a flight path offset function 602. A flight path offset function may be used to determine a new flight path based on information such as information relating to weather in a current flight path, fuel efficiency, shortest path, etc. A weather determining function 606 may be linked to the flight path offset function 602. The functional link may go both ways since weather travel determination may have an effect on a determined a different travel path and selecting a different travel path may have an effect on a determining weather that may be encountered traveling along the second path.

A travel advisory function 604 may also be linked to the flight path offset function 602. Here again the link may go both ways, since a determined different travel path may have an effect on the traffic encountered and traffic may have an effect on determining a different travel path. A further link to the flight path offset function 602 may be to the fuel consumption rate function 610 since a fuel consumption rate will change based on a flight travel path and a flight travel path may be selected at least in part on a determined fuel consumption rate associated with a flight path.

FIG. 6B illustrates an example method of gathering expected insights for some linked functions relating to flight path offset function 602. A flight path offset function related expected insight gathering flow diagram 620 is provided in FIG. 6B for the linked functions illustrated in FIG. 6A. The flight path offset function related expected insight gathering flow diagram 620 is provided as a sequential sequence of blocks. The sequence of blocks may occur in a different order or even in parallel in other embodiments. Hence, the present invention is not limited to the sequential sequence of blocks as set out in FIG. 6B.

At block 624, weather along a travel path is determined. An example of an in cockpit weather determining aircraft system includes an airborne weather radar system. At block 622, traffic is determined with the traffic advisory function 604 that is executed by an application of an aircraft system. An example of an aircraft system used to determine traffic in a traffic alert and collision avoidance system (TCAS). A TCAS monitors airspace around an aircraft for other aircraft equipped with a transponder that transmits a signal that is used to determine the location of the traffic (the aircraft with the transponder in relation to the aircraft using the TCAS to determine traffic).

At block 626, a fuel consumption rate is determined with the fuel consumption rate function 510. As discussed above, the fuel consumption rate will be dependent at least in part on a fight path. At block 628 a flight offset may be determined using the flight offset function 602. The flight offset function may be executed with application 416 of the flight management system 414 of the aircraft 401. A determined flight offset may be based in part on weather information, known traffic, and an expected fuel consumption for a select flight path. The data determined (the expected insights) are linked to their associated functions and are stored in database 105 of memory 106 at block 630. The process continues gathering the expected insights as the aircraft traverses through its flight path to the end of the aircrafts mission.

An example method of verifying if open world data should be applied to aircraft applications of aircraft systems is illustrated in verifying flight off set path open world data flow diagram 650 of FIG. 6C. The verifying flight off set path open world data flow diagram 650 is provided as a sequential sequence of blocks in FIG. 6C. The sequence of blocks may occur in a different order or even in parallel in other embodiments. Hence, the present invention is not limited to the sequential sequence of blocks in FIG. 6C.

At block 652, an aircraft system requests open world data relating to a potential new flight path. The request may be made to be able to use the resources available from an open world data source in determining an optimal flight path offset. The open world data source may look at, for example, weather and fuel consumption rate information in generating a suggested new flight path.

At block 654, the open world data relating to a suggested new flight path is provided to the quality advisor 102. The quality advisor 102 then looks for functional links in the database that have a relation to flight path offset function at block 656. As illustrated in FIG. 6A there is a link between the flight path offset function 602 and the traffic advisory function 604 in this example. At block 658, the result of the linked function (the suggest new flight path) is propagated to the linked function, the traffic advisory function 604, to determine an OWC result.

At block 660, the determined open world data result is compared with an expected insight result. In this case, the proposed new flight path is compared to traffic locations expected insights determined by the traffic advisory function 604. At block 662 it is determined if the open world data results (new proposed flight path) is within an acceptable range of the expected insights. In this case, it is determined at block 662 if the new proposed flight path distances the aircraft far enough away from traffic determined by the traffic advisory function 604.

If it is determined at block 662, the proposed flight path is not within an acceptable range of the expected insights (not distanced far enough from traffic) an alarm response is generated at block 664. In one example, the alarm response provides the pilot an option to disregard the open world data or accept the open world data to be used by the aircraft systems. If it is determined at block 662, the proposed new flight path is within a range of expected insights (proposed flight path distanced is far enough from traffic) the open world data may be provided for use by the aircraft systems at block 665.

Another example of a linked function that may be used to verify open world data applied to aircraft applications of aircraft systems is provided in a verifying flight off set path open world data flow diagram 650 of FIG. 6C. The open world data flow diagram 650 uses the fuel consumption rate function 610. As illustrated in FIG. 6A, the fuel consumption rate function 610 has a functional link to the flight path offset function 602.

At block 656 of the verifying flight off-set path open world data flow diagram 650, the quality advisor 102 determines the functional link between the flight path offset function 602 and the fuel consumption rate function 610. This is accomplished by reviewing the functional links stored in database 105 of memory 106. At block 658 the open world data results are determined. In this example, this is done by propagating data relating to the proposed flight path by the open world data to the fuel consumption rate function 610 to determine a fuel consumption rate associated with the proposed flight path.

The quality advisor 102 compares determined open world data results, which will be an open world data fuel consumption rate result with expected insights (expected consumption rate) at block 660. If it is determined at block 662, that the open world data fuel consumption rate result is not within an acceptable range of the expected insight consumption rate, an alarm response is generated at block 664. A fuel consumption rate may not be within an acceptable range when the fuel consumption rate associated with the proposed flight path would prevent the aircraft from completing the aircraft's mission (i.e. landing at a desired airport). If it is determined at block 662, that the open world data fuel consumption rate is not within an acceptable range of the expected fuel consumption rate, an alarm response is generated at block 664. If it is determined at block 662, that the open world data fuel consumption rate result is within an acceptable range of the expected insight fuel consumption rate, the proposed flight path in the OWD is provided to one or more applications of the aircraft systems for use at block 665.

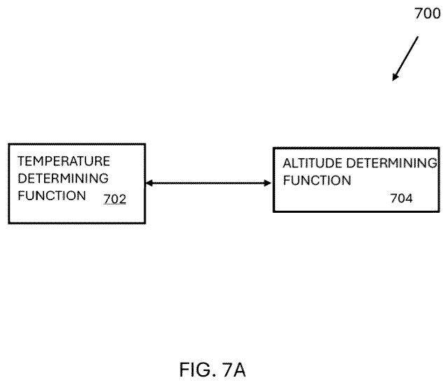

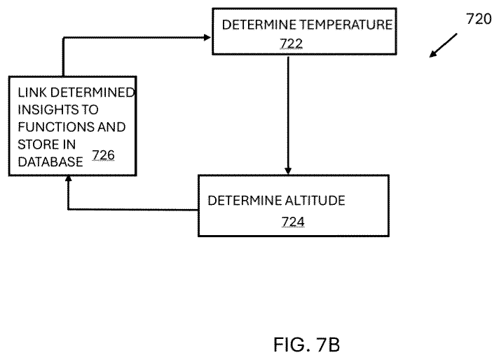

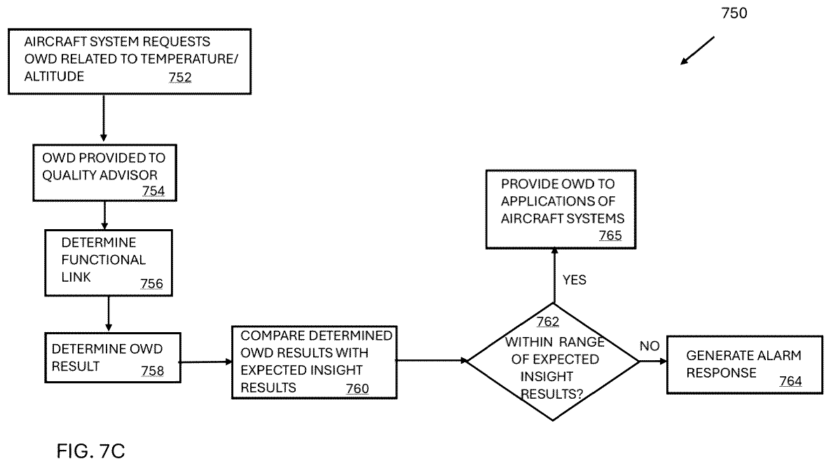

Another example of linked functions 700 that may be stored in database 105 of memory 106 and used for open world data verification is illustrated in FIG. 7A. The linked functions 700 in this example include a temperature determination function 702 and an altitude determining function 704. The temperature determination function 702 may be executed with an application of an aircraft system with the use of sensor data from a sensor, such as a temperature sensor. An example of a temperature sensor used in an aircraft application is a total air temperature sensor (TATS). A TATS includes a heated probe that is mounted on the surface of an aircraft. The altitude determining function 704 may be executed with an application of an aircraft system with the use of sensor data from a sensor, such as a barometer sensor. There is a link between the temperature determination function 702 and the altitude determining function 704 because there is a relationship between altitude and temperature (i.e., the higher the altitude the lower the temperature). Hence, a functional link between the temperature determination function 702 and altitude determining function 704 may be created and stored in database 105 of memory 106.

FIG. 7B illustrates an example method of gathering expected insights in an altitude/temperature linked function flow diagram 720 for the linked functions illustrated in FIG. 7A. The altitude/temperature linked function flow diagram 720 is provided as a sequential sequence of blocks. The sequence of blocks may occur in a different order or even in parallel in other embodiments. Hence, the present invention is not limited to the sequential sequence of blocks as set out in FIG. 7B.

At block 722 an expected temperature insight is determined. The expected temperature insight is determined with the temperature determining function 702 as discussed above. At block 724 an expected altitude insight is determined. The expected altitude insight is determined with the altitude determining function 704 as discussed above. The determined expected temperature and altitude insights along with a link between the functions are stored in database 105 of memory 106 at block 726. The process continues determining the expected temperature and altitude insights as the aircraft traverses through the flight path to the end of the mission of the aircraft.

An example method of verifying open world data applied to aircraft applications of aircraft systems is illustrated in the altitude/temperature open world data flow diagram 750 of FIG. 7C. The altitude/temperature open world data flow diagram 750 is provided as a sequential sequence of blocks in FIG. 7C. The sequence of blocks may occur in a different order or even in parallel in other embodiments. Hence, the present invention is not limited to the sequential sequence of blocks in FIG. 7C.

At block 752, an aircraft system requests open world data. In this example, the open world data requested relates to either temperature or altitude. In response the open world data source 108 generates the requested open world data and provides the open world data to the quality advisor 102 at block 754. The quality advisor 102 determines functional links that may be associated with the open world data at block 756. In this example, since the open world data is related to one of temperature and altitude, the functional links include the temperature determining function 702 and the altitude determining function 704.

At block 758, the quality advisor 102 determines an open world data result for the linked function. For example, if the received open world data related to temperature, the quality advisor will determine a corresponding altitude (open world data altitude result) and if the received open world data related to an altitude, the quality advisor 102 will determine an associated temperature (open world temperature result). At block 760, the open world result is compared with the expected insights of an associated function that is stored in database 105 of memory 106. If the open world result relates to a temperature, expected insights provided by the temperature determining function 702 and stored in the database of memory 106 are used as the expected insights. If the open world data result relates to an altitude, expected insights provided by the altitude determining function 704 and stored in the database of memory 106 are used as the expected insights.

It is determined at block 762 if the open world data result is within a range of the expected insights. In the open world temperature result example, it is determined if the open world temperature result is within a range of a temperature that would be found at a given altitude (i.e., within an expected temperature insight range). In the altitude result example, it is determined if the open world data altitude result is within a range of an altitude for an associated temperature (within an expected altitude insight range).

If it is determined at block 762, the open world data result is not within a range of an expected insight result, an alarm response is generated at block 764. If it is determined at block 762, the open world data result is within a range of an expected insight result, the open world data related to temperature or altitude is provided to the aircraft systems for use at block 765.

Further, examples may validate runway information from open world data source 108. An aircraft application of an aircraft system may execute functions relating to taking off and landing an aircraft at a runway. In a landing example, the functions may include a landing speed function, landing length of runway needed function, weight of aircraft function, a fuel available function and a landing function. The landing function may be part of an application of a system such as an enhanced ground proximity warning system (EGPWS) that provides landing advisories to the pilot. The landing speed function, the landing runway length function, the weight of the aircraft function and the fuel available function may be executed by applications in the flight management system 414 or runway analyzer system 410.

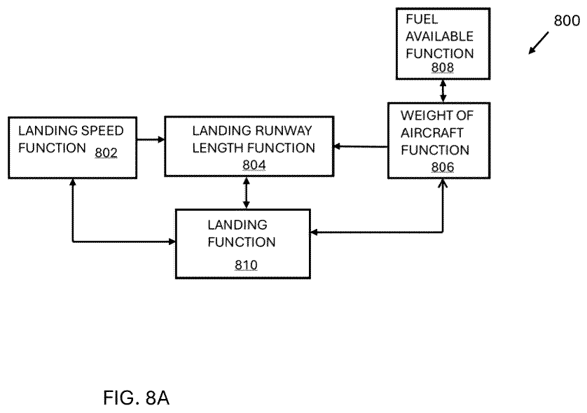

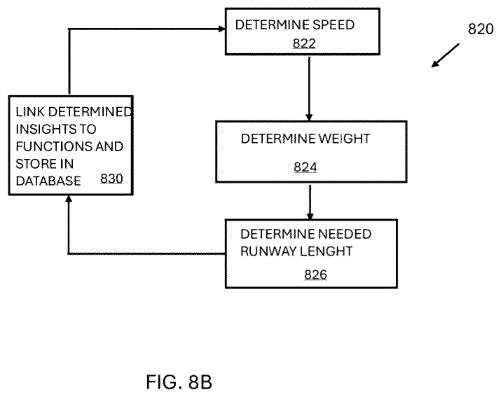

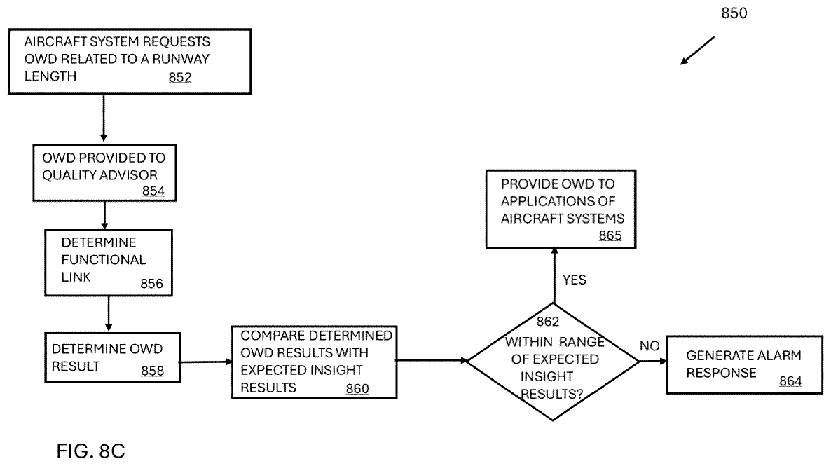

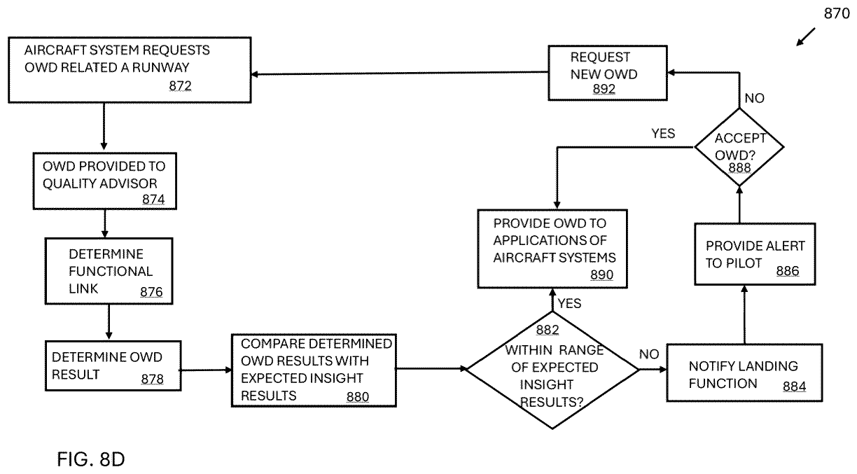

An example of linked functions 800 relating to a landing example are illustrated in FIG. 8A. As illustrated, the landing speed function 802 is linked to a landing runway length function 804, since the speed of an aircraft is a factor in how far the aircraft will travel on a runway when landing. The weight of the aircraft function 806 is also linked to the landing runway length function 804 since the weight of the aircraft is another factor that determines how far an aircraft will travel on a runway when landing. The fuel available function 808 is linked to the weight of the aircraft function 806 since the weight of the aircraft is dependent on the amount of fuel the aircraft is carrying.

Further as illustrated in this example, the landing function 810 is linked to the landing speed function 802, the weight of aircraft function 806 and the landing runway length function 804. The landing function 810 may be executed by an application in an EGPWS. The landing function 810 may use information relating to the aircraft speed, aircraft weight and landing runway length in generating advisories. Accordingly, the landing speed function 802, the landing runway length function 804 and weight of aircraft function 806 may be linked to the landing function 810.

FIG. 8B illustrates an example method of gathering expected insights for linked functions during a landing. An expected landing insight gathering flow diagram 820 for linked functions is illustrated in FIG. 8A. The expected landing insight gathering flow diagram 820 is provided as a sequential sequence of blocks. The sequence of blocks may occur in a different order or even in parallel in other embodiments. Hence, the present invention is not limited to the sequential sequence of blocks as set out in FIG. 8B.

At block 822 the expected speed insight of the aircraft is determined with the landing speed function 802. In one example, the expected speed insight of the aircraft is determined using an air speed indicator (ASI). An ASI compares an aircraft's pitot pressure and static pressure to calculate a forward speed. At block 824, an expected weight insight of the aircraft is determined by the weight of aircraft function 806. In one example, this is done by adding the weight of the fuel in the aircraft with the weight of the aircraft loaded without fuel. At block 826, the expected length insight of the runway needed to land the aircraft is determined with the landing runway length function 804. Factors in determining the expected length insight of the runway include knowing the speed of the aircraft and the weight of the aircraft.

The determined expected insights are linked to their associated function and stored in database 105 of memory 106 at block 830. The process continues in the background through the landing procedure generating the expected results associated with the linked functions.

An example method of verifying open world data applied to aircraft applications of aircraft systems is illustrated in the verifying landing open world data flow diagram 850 of FIG. 8C. The verifying landing open world data flow diagram 850 is provided as a sequential sequence of blocks in FIG. 8C. The sequence of blocks may occur in a different order or even in parallel in other embodiments. Hence, the present invention is not limited to the sequential sequence of blocks in FIG. 8C.

At block 852, an aircraft system requests open world data. In this example, the open world data requested relates to a runway length. In response, the open world data source 108 generates the open world data and provides the open world data to the quality advisor 102 at block 854. The quality advisor 102 determines functional links associated with the open world data at block 856. In this example, since the open world data is related to landing, the functional links include the landing speed function 802 and the weight of the aircraft function 806.

At block 858, the quality advisor 102 determines an open world data result for the linked function. For example, the received open world data results may include aircraft speed and aircraft weight information that could safely land on the runway length provided by the open world data. The open world data results are compared to the expected insights stored in the database 105 of the memory 106 at block 860.

It is determined at block 862 if the open world data result is within a range of the expected insights. The expected insight may relate to speed and weight in this example. If it is determined at block 862, that the open world data result is not within a range of an expected insight result, an alarm response is generated at block 864. If it is determined at block 862, the open world data result is within a range of an expected insight result, the open world data is provided to the applications in the aircraft systems for use at block 865. This may include the application that implements the landing function.

Another example method of verifying open world data applied to aircraft applications of aircraft systems is illustrated in a verifying runway open world data flow diagram 870 of FIG. 8D. The verifying landing open world data flow diagram 870 is provided as a sequential sequence of blocks in FIG. 8D. The sequence of blocks may occur in a different order or even in parallel in other embodiments. Hence, the present invention is not limited to the sequential sequence of blocks in FIG. 8D.

In this runway open world data example, the open world data relates to the selection of a runway to safely land the aircraft. The linked functions are used to verify the open world data selected runway will accommodate the aircraft in landing. If the runway does not, the pilot in this example requests new open world data through the landing function 810.

At block 872, an aircraft system requests open world data. In this example, the open world data requested relates to a runway. In response, the open world data source 108 generates the open world data and provides the open world data to the quality advisor 102 at block 874. The quality advisor 102 determines functional links associated with the open world data at block 876. In this example, since the open world data is related to a runway, the functional links relating to landing at the runway would include the landing speed function 802, the weight of the aircraft function 806 as well as the landing function 810.

At block 878, the quality advisor 102 determines an open world data result for a linked function. For example, the received open world results may include aircraft speed and aircraft weight information to safely land on a runway length provided by the open world data. The open world results are compared to the expected insights stored in database 105 of memory 106 at block 880.

It is determined at block 882 if an open world data result is within a range of am expected insight result. The expected insight may relate to speed or weight in this example. If it is determined at block 862, the open world data result is within a range of an expected insight result, the open world data is provided to the applications in the aircraft systems for use. This may include the application that implements the landing function.

If it is determined at block 882, the open world data result is not within a range of an expected insight result, the landing function is notified at block 884. The landing function 810 provides an alert to the pilot (vehicle operator) at block 886. The pilot in this example is given the opportunity to except the open world data at block 888 even with the alert. If the pilot excepts the open world data, the open world data is provided to the application of the aircraft systems at block 890. If the pilot does not except the open world data, the pilot at block 892 may request that the open world data source 108 provide other open world data and the process continues at block 872. In this runway open world data example, the open world data relates to the selection of a runway to land the aircraft. The functional links are used to verify a selected runway will accommodate the aircraft in landing. If it does not, the pilot in this example requests new open world data (i.e. the selection of a new runway).

### EXAMPLE EMBODIMENTS

Example 1 includes a system to verify open world data applied to vehicle applications of vehicle systems. The system includes a plurality of vehicle applications and a quality advisor. The plurality of the vehicle applications configured to at least in part provide information to control operations of a vehicle. The quality advisor provides an interface between the open world data and the plurality of vehicle applications. The quality advisor includes a memory and a processor. The memory is used to store operating instructions and at least one database that includes functional links between vehicle applications of the plurality of vehicle applications. The processor is configured to implement the operating instructions stored in the memory. The processor is configured to verify the open world data by determining if the open world data provides expected insights across the vehicle applications with the functional links stored in the at least one database. The processor is further configured to do at least one of preventing the vehicle applications from receiving the open world data and presenting the open world data to a vehicle operator when the processor determines that the open world data does not provide the expected insights across the vehicle applications with the functional links.

Example 2 includes the system of Example 1, wherein the processor is configured to run tests in a background with data generated by vehicle systems at least when the vehicle traverses through a travel path to determine the expected insights.

Example 3 includes the system of any of the Examples 1-2, wherein the processor is configured to monitor generated expected insights for suspicious expected insights.

Example 4 includes the system of Example 3, wherein the processor is configured to log detected expected insights in the memory.

Example 5 includes the system of Example 4, wherein the processor is configured to prevent test data that produced the suspicious expected insight from propagating through linked functions.

Example 6 includes the system of any of the Examples 1-5, further including a plurality of vehicle systems. Each vehicle application implemented by an associated vehicle system of the vehicle systems.

Example 7 includes the system of any of the Examples 1-6, wherein the open world data is provided by at least one of an electronic flight bag, an installed non-certified open world computer in a flight deck of an aircraft, and a communication interface to a cloud application.

Example 8 includes the system of any of the Examples 1-7, wherein the processor configured to verify the open world data by determining if the open world data provides expected insights across the vehicle applications with the functional links stored in the at least one database further comprises the processor configured to determine if open world data results are within acceptable ranges of expected insights across the vehicle applications with the functional links.

Example 9 includes the system of any of the Examples 1-8, wherein the processor is configured to provide the open world data to the vehicle applications when the processor determines the open world results are within the acceptable ranges of the expected insights across the vehicle applications with the functional links.

Example 10 includes the system of any of the Examples 1-9, further including an input/output configured to at least convey an alarm response to a vehicle operator when the open world data does not provide the expected insights across the across the vehicle applications with the functional links.

Example 11 includes a system to verify open world data applied to vehicle applications of vehicle systems. The system includes a plurality of vehicle applications and a quality advisor. The plurality of vehicle applications are configured to at least in part control operations of a vehicle. The quality advisor provides an interface between the open world data and the plurality of vehicle applications. The quality advisor includes a memory and processor. The memory is used to store operating instructions and at least one database that includes functional links between the plurality of vehicle applications. The processor is configured to implement the operating instructions stored in the memory. The processor is configured to run tests in a background with data generated by vehicle systems as the vehicle traverses through a travel path to determine expected insights associated with the plurality of vehicle applications. The processor is configured to verify the open world data by comparing open world data results with expected insights across vehicle applications with the functional links. The processor is further configured to provide the open world data to the vehicle applications when the processor determines the open world results are within the acceptable ranges of the expected insights across the vehicle applications with the functional links.

Example 12 includes the system of Example 11, wherein the processor is further configured to do at least one of preventing the vehicle applications from receiving the open world data and presenting the open world data to a vehicle operator when the processor determines that the open world data does not provide the expected insights across the plurality of vehicle applications.

Example 13 includes the system of any of the Examples 11-12, wherein the processor is configured to monitor generated expected insights for suspicious expected insights and when suspicious expected insights are detected preventing test data that produced the suspicious expected insight from propagating through vehicle applications with the functional links.

Example 14 includes a method to verify open world data applied to vehicle applications of vehicle systems. The method including interfacing communications between an open world data source and the vehicle systems with a quality advisor; generating expected insights for functions executed by the vehicle applications using data provided by the vehicle systems as a vehicle that contains the vehicle system at least transverses along a travel path; comparing open world data results from the open world data provided by the open world source with the expected insights across vehicle applications with functional links using the quality advisor; and providing the open world data to at least one vehicle application when the comparing of the open world data results with the expected insights across the vehicle applications with functional links are within an acceptable range.

Example 15 includes the method of Example 14, further including preventing the use of the open world data in the vehicle applications when the comparison of the open world data results are not within the acceptable range of the expected insights across the vehicle application with functional links.

Example 16 includes the method of any of the Examples 14-15, wherein the generating expected insights for the functions executed by the vehicle applications using the data provided by the vehicle systems, further includes running tests in a background with a quality advisor with the data generated by the vehicle applications of the vehicle systems.

Example 17 includes the method of any of the Examples 14-16, further including generating an alarm response when the comparison of the open world data results are not within the acceptable range of the expected insights across the vehicle application with functional links.

Example 18 includes the method of any of the Examples 14-17, further including providing a vehicle operator one of an option of accepting the open world data and request new open world data when the comparison of the open world data results are not within the acceptable range of the expected insights across the vehicle application with functional links.

Example 19 includes the method of any of the Examples 14-18, further including determining the functional links across the plurality of vehicle applications; and storing the functional links across the plurality of vehicle applications for use by the quality advisor.

Example 20 includes the method of any of the Examples 14-19, further including monitoring the generated expected insights for suspicious expected insights; and when suspicious expected insights are detected, preventing the data that produced the suspicious expected insights from propagating through vehicle applications with the functional links.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A system to verify open world data applied to vehicle applications of vehicle systems, the system comprising:
a plurality of the vehicle applications configured to at least in part provide information to control operations of a vehicle; and
a quality advisor providing an interface between the open world data and the plurality of vehicle applications, the quality advisor including,
a memory to store operating instructions and at least one database that includes functional links between vehicle applications of the plurality of vehicle applications, and
a processor configured to implement the operating instructions stored in the memory, the processor configured to verify the open world data by determining if open world data results provide expected insights across the vehicle applications with the functional links stored in the at least one database, the processor further configured to do at least one of preventing the vehicle applications from receiving the open world data and presenting the open world data to a vehicle operator when the processor determines that the open world data does not provide the expected insights across the across the vehicle applications with the functional links.

2. The system of claim 1, wherein the processor is configured to run tests in a background with data generated by the vehicle systems at least when the vehicle traverses through a travel path to determine the expected insights.

3. The system of claim 2, wherein the processor is configured to monitor generated expected insights for suspicious expected insights.

4. The system of claim 3, wherein the processor is configured to log detected expected insights in the memory.

5. The system of claim 3, wherein the processor is configured to prevent test data that produced the suspicious expected insight from propagating through the vehicle applications with the functional links.

6. The system of claim 1, further comprising:
a plurality of vehicle systems, each vehicle application implemented by an associated vehicle system of the vehicle systems.

7. The system of claim 1, wherein the open world data is provided by at least one of an electronic flight bag, an installed non-certified open world computer in a flight deck of an aircraft, and a communication interface to a cloud application.

8. The system of claim 1, wherein the processor configured to verify the open world data by determining if the open world data results provides the expected insights across the vehicle applications with the functional links stored in the at least one database further comprises, the processor configured to determine if the open world data results are within acceptable ranges of expected insights across the vehicle applications with the functional links.

9. The system of claim 8, wherein the processor is configured to provide the open world data to the vehicle applications when the processor determines the open world results are within the acceptable ranges of the expected insights across the vehicle applications with the functional links.

10. The system of claim 1, further comprising:
an input/output configured to at least convey an alarm response to the vehicle operator when the open world data does not provide the expected insights across the across the vehicle applications with the functional links.

11. A system to verify open world data applied to vehicle applications of vehicle systems, the system comprising:
a plurality of vehicle applications configured to at least in part control operations of a vehicle; and
a quality advisor providing an interface between the open world data and the plurality of vehicle applications, the quality advisor including,
a memory to store operating instructions and at least one database that includes functional links between the plurality of vehicle applications, and
a processor configured to implement the operating instructions stored in the memory, the processor configured to run tests in a background with test data generated by the vehicle systems as the vehicle traverses through a travel path to determine expected insights associated with the plurality of vehicle applications, the processor configured to verify the open world data by comparing open world data results with expected insights across the vehicle applications with the functional links, the processor configured to provide the open world data to the vehicle applications when the processor determines the open world results are within acceptable ranges of the expected insights across the vehicle applications with the functional links.

12. The system of claim 11, wherein the processor is further configured to do at least one of preventing the vehicle applications from receiving the open world data and presenting the open world data to a vehicle operator when the processor determines that the open world data does not provide the expected insights across the plurality of vehicle applications.

13. The system of claim 11, wherein the processor is configured to monitor generated expected insights for suspicious expected insights and when the suspicious expected insights are detected preventing the test data that produced the suspicious expected insight from propagating through the vehicle applications with the functional links.

14. A method to verify open world data applied to vehicle applications of vehicle systems, the method comprising:
interfacing communications between an open world data source and the vehicle systems with a quality advisor;
generating expected insights for functions executed by the vehicle applications using data provided by the vehicle systems as a vehicle that contains the vehicle systems at least transverses along a travel path;
comparing open world data results from the open world data provided by the open world source with the expected insights across vehicle applications with functional links using the quality advisor; and
providing the open world data to at least one vehicle application when the comparing of the open world data results with the expected insights across the vehicle applications with the functional links are within an acceptable range.

15. The method of claim 14, further comprising:
preventing the use of the open world data in the vehicle applications when a comparison of the open world data results are not within the acceptable range of the expected insights across the vehicle application with the functional links.

16. The method of claim 14, wherein generating the expected insights for the functions executed by the vehicle applications using the data provided by the vehicle systems, further comprises:
running tests in a background with the quality advisor with the data generated by the vehicle applications of the vehicle systems.

17. The method of claim 14, further comprising:
generating an alarm response when a comparison of the open world data results are not within the acceptable range of the expected insights across the vehicle applications with the functional links.

18. The method of claim 14, further comprising:
providing a vehicle operator one of an option of accepting the open world data and request new open world data when a comparison of the open world data results are not within the acceptable range of the expected insights across the vehicle applications with the functional links.

19. The method of claim 14, further comprising:
determining the functional links across the vehicle applications; and
storing the functional links across the vehicle applications for use by the quality advisor.

20. The method of claim 14, further comprising:
monitoring the generated expected insights for suspicious expected insights; and
when the suspicious expected insights are detected, preventing the data that produced the suspicious expected insights from propagating through the vehicle applications with the functional links.
